(19) United States
(12) Patent Application Publication
(10) Pub. No.: US 2026/0248105 A1
(43) Pub. Date: Aug. 27, 2026

(54) Dog Leash with an Open-Ended Pocket for Penlight

(71) Applicant: Nicolina Mastroianni, Quebradillas, PR (US)

(72) Inventor: Nicolina Mastroianni, Quebradillas, PR (US)

(21) Appl. No.: 19/065,938

(22) Filed: Feb. 27, 2025

(51) Int. Cl. A01K 27/00

(52) U.S. Cl. CPC A01K 27/008; A01K 27/003; A01K 27/006

(57) ABSTRACT

A dog leash incorporating an integrated flashlight housed within a secure Velcro sleeve is disclosed. The sleeve is sewn directly onto the leash body and includes a closure flap to prevent accidental detachment of the flashlight during use. The design provides a stable, forward-facing beam of light to improve safety and visibility during low-light or nighttime walks. Constructed of weather-resistant materials and enhanced with reflective stitching, the leash ensures durability and 360° visibility. The Velcro sleeve allows for easy removal and replacement of the flashlight, offering both convenience and reliability in various outdoor conditions.

### BACKGROUND OF THE INVENTION

Pet owners often face challenges walking their dogs in low-light conditions. Traditional leashes do not provide a convenient way to carry lighting devices, which can compromise safety. There is a need for a leash that provides integrated illumination while maintaining durability, comfort, and safety.

### SUMMARY OF THE INVENTION

This invention relates to a dog leash that incorporates an integrated flashlight to improve visibility and safety during nighttime or low-light walks. The leash features a compact, slim flashlight securely attached to the outside of the sleeve providing an illuminated path for the dog owner. The flashlight is housed in a custom-designed Velcro sleeve, which ensures that the flashlight remains firmly in place during use. The Velcro sleeve allows for easy attachment and removal of the flashlight, while also offering a secure fit to prevent accidental detachment.

The leash is designed with durability in mind, using weather-resistant materials for both the leash and flashlight components, making it ideal for various outdoor conditions. This innovation enhances the safety and convenience of walking pets in dark environments, offering a hands-free lighting solution without the need for additional equipment.

### BRIEF DESCRIPTION OF THE DRAWINGS

FIG. 1 is a perspective view of a part of a dog leash showing an integrated flashlight housing, in accordance with the present disclosure.

FIG. 2 is a perspective view of the dog leash shown in FIG. 1.

FIG. 3 is another perspective view of the dog leash shown in FIG. 1.

FIG. 4 shows the dog leash of FIG. 1 attached to a dog collar.

FIGS. 5A-C show wide-angle lighting and reflectiveness in low-lit areas, provided by the dog leash with the integrated flashlight housing, as shown in FIG. 1.

FIG. 6 shows a perspective view of the dog leash of FIG. 1 attached to the dog collar, with the integrated flashlight housing seen.

### DETAILED DESCRIPTION

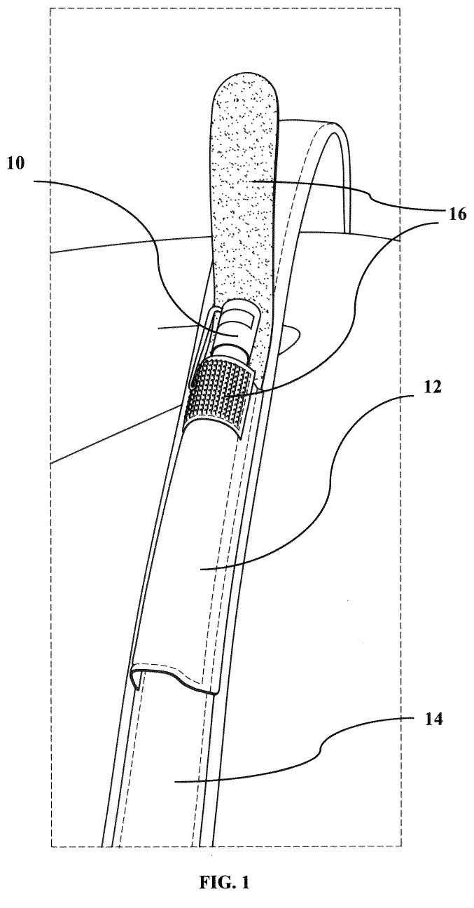

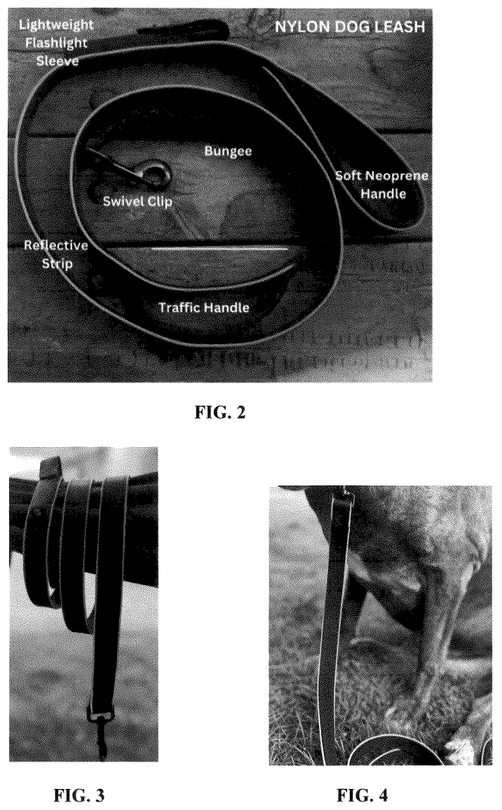

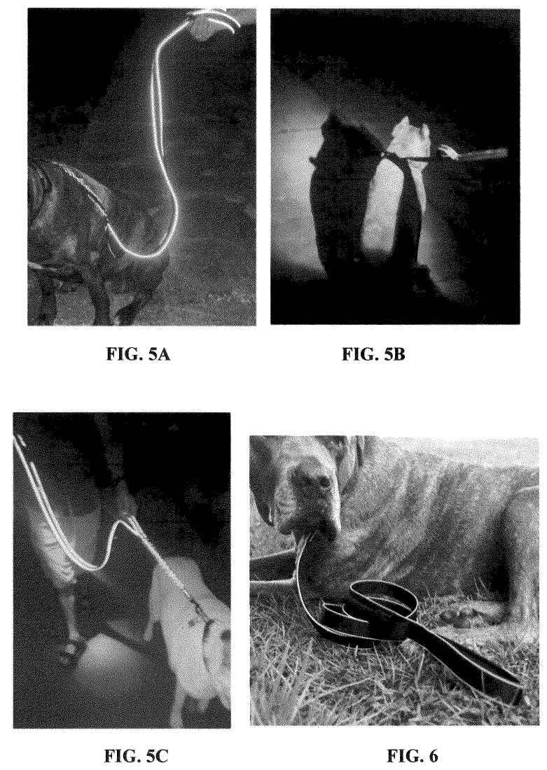

FIG. 1 shows an integrated flashlight housing 10 positioned within a sewn-in pocket 12 on the sturdy leash 14, which is reinforced by a Velcro piece 16, thereby providing a Velcro sleeve, with the sturdy leash 14 holding the Velcro sleeve in place.

The Velcro sleeve is a key feature of this dog leash, providing both security and convenience for the integrated flashlight. It is sewn directly onto the body of the leash, ensuring durability and a secure attachment point for the flashlight. The sleeve is made from a strong, high-quality material that matches the overall design of the leash, providing added strength and resistance to wear and tear, especially in outdoor conditions.

The Velcro sleeve is designed with an opening at the top to slide the flashlight inside the sleeve, and the bottom of the sleeve allows the light to beam outward. A Velcro flap covers the top of the flashlight which allows the flashlight to stay secure and be firmly held in place during use, preventing it from slipping or shifting as the dog moves or the leash is pulled. This ensures that the flashlight remains stable and effective at illuminating the path ahead.

1. A dog leash comprising an integrated sleeve for securely housing a flashlight to provide illumination during low-light or nighttime walks,
wherein the sleeve defines an interior cavity configured to receive the flashlight therein.
wherein the sleeve comprises a first open end for inserting the flashlight and a second open end opposite the first open end, the second open end being configured to permit light to project from the flashlight therethrough when the flashlight is accommodated in the sleeve.
wherein the sleeve comprises a closure flap configurable between an open position for accessing the interior cavity and a closed position for securely retaining the flashlight within the interior cavity by covering the first open end, and
wherein the sleeve comprises a hook and loop fastener configured to secure the closure flap in the closed position.

2. The dog leash of claim 1, wherein the sleeve is sewn directly onto the leash for durability.

3. (canceled)

4. The dog leash of claim 1, further comprising weather-resistant materials and reflective stitching for all-weather use.

5. The dog leash of claim 1, further comprising an elongated leash body having a first end configured to be held by a user and a second end configured to be attached to a dog collar, wherein the sleeve is sewn onto the leash body between the first and second ends.

6. The dog leash of claim 1, wherein the sleeve is configured to accommodate an entire body of the flashlight therein.

7. The dog leash of claim 1, wherein the closure flap is provided at the first open end of the sleeve.
